(19) United States
(12) Patent Application Publication
(10) Pub. No.: US 2004/0089981 A1
(43) Pub. Date: May 13, 2004

(54) Method for manufacturing animal chew toy

(76) Inventor: Charles A. Byrne, Mammoth Lakes, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/701,052

(22) Filed: Nov. 3, 2003

Related U.S. Application Data
(63) Continuation-in-part of application No. 10/414,630, filed on Apr. 15, 2003.
(60) Provisional application No. 60/372,849, filed on Apr. 16, 2002.

(51) Int. Cl. B29C 35/00

(52) U.S. Cl. 264/326

(57) ABSTRACT

A method for manufacturing animal chew toy includes providing layers of rubber material, such as tire rubber, which are cut into a general shape of an animal chew toy. A floss material comprised of a synthetic fiber mesh fabric, is also cut into the general shape of the animal chew toy and placed between the first and second layers of rubber material. These layers are molded under pressure and heat into the animal chew toy which is durable and serves to floss the teeth and gums of the animal when chewed. Ropes, animal treats, or buoyant inserts can be associated with the animal chew toy as desired.

### RELATED APPLICATION

This application is a continuation-in-part of U.S. patent application Ser. No. 10/414,630, filed Apr. 15, 2003, which claims priority from U.S. Provisional Application Serial No. 60/372,849, filed Apr. 16, 2002.

### BACKGROUND OF THE INVENTION

The present invention generally relates to animal chew toys. More particularly, the present invention relates to a method for manufacturing animal chew toys having floss material embedded therein.

Dogs inherently enjoy the need to chew. Dogs need chew toys for teething as puppies and general chewing as the dogs mature for the health of the dog and to avoid destruction of household items.

Currently, there are many rubber dog toys of various shapes made from solid rubber using standard compression molding processes, or cast molded from vinyl. Animal chew toy products made from plastic such as nylon or vinyl are too hard. However, such products made from natural rubber are not very durable and must continually be replaced. Very few animal chew toys provide any dental or health benefits to the animal.

A real tire dog chew toy developed by CB Worldwide is made from die-cutting tire sidewalls into various shapes, such as bones, etc. Although dogs like to chew on tires, it has been found that the tires include metal beads or wires within the rubber of the tires which can be harmful to a dog if bitten.

Accordingly, there is a need for chew toys which are durable and provide a health benefit to the animal. The present invention fulfills these needs and provides other related advantages.

### SUMMARY OF THE INVENTION

The present invention resides in a method for manufacturing animal chew toy which is comprised of a durable material which is pliable and soft enough for an animal, such as a dog, to chew. Rubber, and particularly a tire rubber material composed of natural or synthetic rubber mixed with carbon black has been found to be sufficiently durable yet pliable and appealing to the dog. A desirable scent material may be added to the tire rubber for masking any unpleasant smell to the animal.

First and second layers of the rubber material are cut into a general configuration or size of the resulting animal chew toy. A floss material, which is also cut into the general shape or size of the animal chew toy, is placed between the first and second layers of rubber material. Such floss material is typically comprised of a mesh fabric of synthetic fibers, such as nylon or polyester. Such fibers provide strength and also serve as a tooth floss for the animal.

The first and second layers of rubber material and the layer of floss material are then compressed under pressure and heat to mold the layers into the animal chew toy.

The animal chew toy may have a rope attached thereto or an animal treat retained in a cavity thereof.

A buoyant insert, such as a closed cell foam, may be associated wit the animal chew toy such as disposing the insert within a cavity of the animal chew toy so the animal chew toy will float.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a diagrammatic view of scent being added to a rubber material used in accordance with the present invention, and formed into sheets embedded with synthetic fibers, and cut into strips for manufacturing the animal chew toys of the present invention;

FIG. 2 is a perspective view of a strip of the rubber material of the present invention wrapped around a rigid cylindrical mold;

FIG. 3 is a perspective view of the strip of rubber material of FIG. 2 formed into a cylindrical structure;

FIG. 4 is a perspective view of the cylindrical strip of FIG. 3 placed on a forming device used in accordance with the present invention;

FIG. 5 is a perspective view of the formed rubber material placed within a compression mold;

FIG. 6 is a perspective view of an animal chew toy having a tire configuration after the compression molding and disposed in a base of the mold;

FIG. 7 is a perspective view of the completed animal chew toy having the tire configuration; and

FIG. 8 is an exploded perspective view illustrating sheets of rubber and floss material inserted within a mold to make an animal chew toy in accordance with the present invention;

FIG. 9 is a perspective view of the mold compressing the layers of rubber and floss material;

FIG. 10 is a perspective view of the mold with the top portion removed therefrom an animal chew toy formed;

FIG. 11 is a perspective view of an animal chew toy resulting from the molding process illustrated in FIGS. 8-10, and having excess rubber extending therefrom;

FIG. 12 is a perspective view similar to FIG. 11, with the excess rubber trimmed away from the animal chew toy;

FIG. 13 is an exploded perspective view of sheets of rubber and floss material inserted within another mold for manufacturing a flying disk animal chew toy;

FIG. 14 is a perspective view illustrating the mold placed over the layers;

FIG. 15 is a perspective view of the mold being compressed upon the layers of FIG. 13;

FIG. 16 is a perspective view of a resultant flying disk animal chew toy residing in a bottom mold portion;

FIG. 17 is a perspective view of the resultant flying disk animal chew toy;

FIG. 18 is a perspective view of the flying disk animal chew toy of FIG. 17, having a buoyant foam insert disposed therein;

FIG. 19 is a cross-sectional view taken generally lines 19-19 of FIG. 18, illustrating the buoyant insert therein;

FIG. 20 is a perspective view of the flying disk animal chew toy having a central aperture portion thereof closed off with a fabric;

FIG. 21 is a perspective view of the flying disk animal chew toy folded for storage;

FIG. 22 is a perspective view of another animal chew toy in the form of a tire having a rope extending therefrom;

FIG. 23 is a cross-sectional view taken generally along line 23-23 of FIG. 22, illustrating a buoyant insert disposed within a central hollow portion of the tire animal chew toy of FIG. 22;

FIG. 24 is a cross-sectional view taken generally along line 24-24 of FIG. 22, illustrating a buoyant foam ring insert disposed within a circumferential internal cavity of the tire animal chew toy;

FIG. 25 is a perspective view of a retriever animal chew toy embodying the present invention;

FIG. 26 is a cross-sectional view taken generally along line 26-26 of FIG. 25, illustrating a buoyant foam insert disposed within an internal cavity thereof;

FIG. 27 is a partially exploded perspective view illustrating insertion of the buoyant foam insert into the retrieval animal chew toy;

FIG. 28 is a perspective view of a bone animal chew toy embodying the present invention and having animal treats therein; and

FIG. 29 is a cross-sectional view taken generally along line 29-29 of FIG. 28, illustrating the placement of animal treats disposed within a cavity of the animal chew toy.

### DETAILED DESCRIPTION OF THE PREFERRED EMBODIMENTS

The present invention resides in a method for manufacturing animal chew toys which are more durable than prior soft rubber toys, yet not harmful to the mouth of the animal. It has been found that tire rubber is very durable, yet soft enough for a dog to chew. It has also been found that rubber can be reinforced with synthetic fibers, which also serves to floss the teeth and gums of the dog or other animal chewing on the toy.

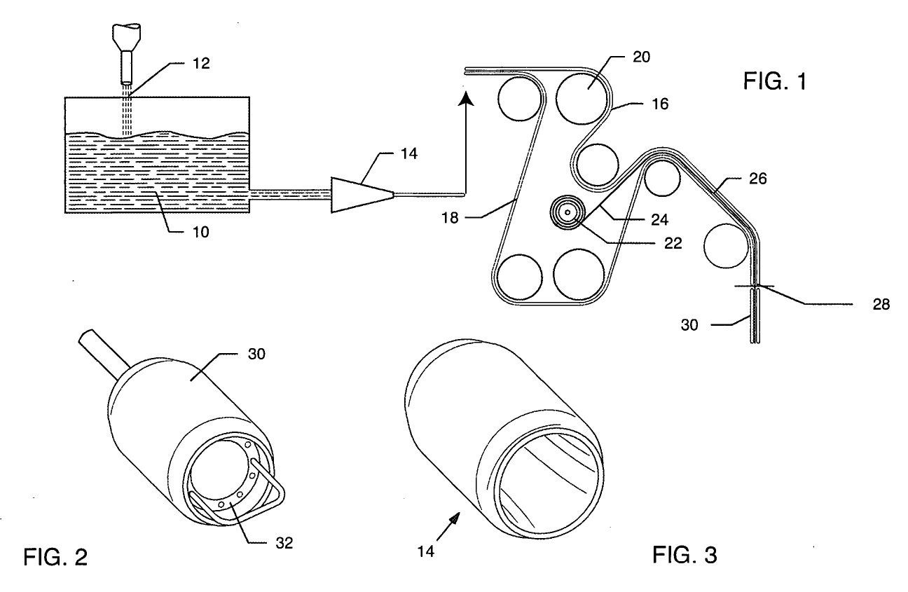

With reference to FIGS. 1-7, the present invention will be described as a particular method for creating a chew toy having a tire configuration. However, any chew toy comprised of durable tire rubber and reinforced with synthetic fibers are intended to be within the scope of the present invention.

With reference now to FIG. 1, in one embodiment of the present invention, a source of rubber material 10 is provided. Typically, the rubber material 10 comprises tire rubber material which is composed of natural or synthetic rubber mixed with carbon black, as is well-known in the art. Typical tire rubber has a unique and strong smell which might deter some dogs from using the chew toys created by the rubber 10. Accordingly, in a particularly preferred embodiment, a scent 12 is added to the rubber material 10. It has been found that a lavender/mint scent sufficiently masks the strong odor of the rubber material 10 and is pleasant to the animal. The rubber material 10 is sent through an extruder 14 which forms thin sheets 16 and 18 of rubber material. Rollers 20 may be used to create and handle the sheets 16 and 18 of rubber material.

Synthetic fiber 22 is embedded into the sheets 16 and 18 of rubber material. Typically, the two layers 16 and 18 of rubber material are rolled using rollers 20 onto a layer 24 of either two-ply or four-ply nylon or polyester, to create a single sheet 26 of rubber material embedded with the synthetic fiber 22. This sheet 26 is then cut 28 into individual strips 30 of appropriate dimension for forming the chew toy.

With reference now to FIGS. 2 and 3, the strip 30 is placed around a rigid form 32, typically comprised of metal. The result is a generally cylindrical structure 34 of rubber material, as illustrated in FIG. 3.

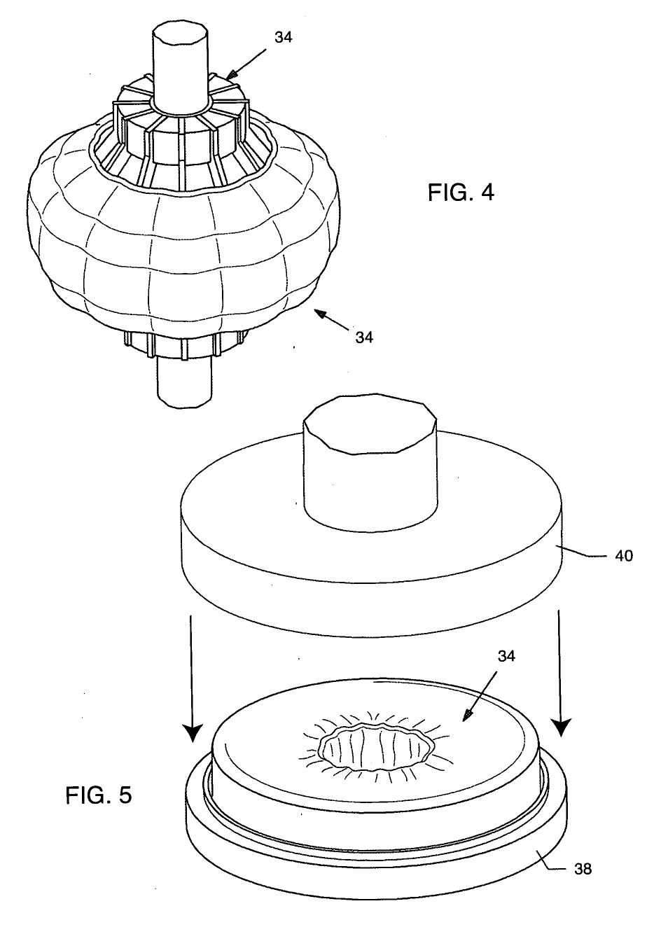

With reference now to FIG. 4, the generally cylindrical rubber material structure 34 is placed on a fixture 36 which is capable of expanding and forming the cylindrical structure 34 into an initial, rough tire shape. The now donut or tire-shaped member 34 is removed from the expansion fixture 36 and inserted into a base 38 of a compression mold, comprised of the base 38 and upper member 40, with any additional inserts or the like as is well-known in the compression molding art. The rubber tire form 34 is then compression-molded into the predetermined chew toy configuration.

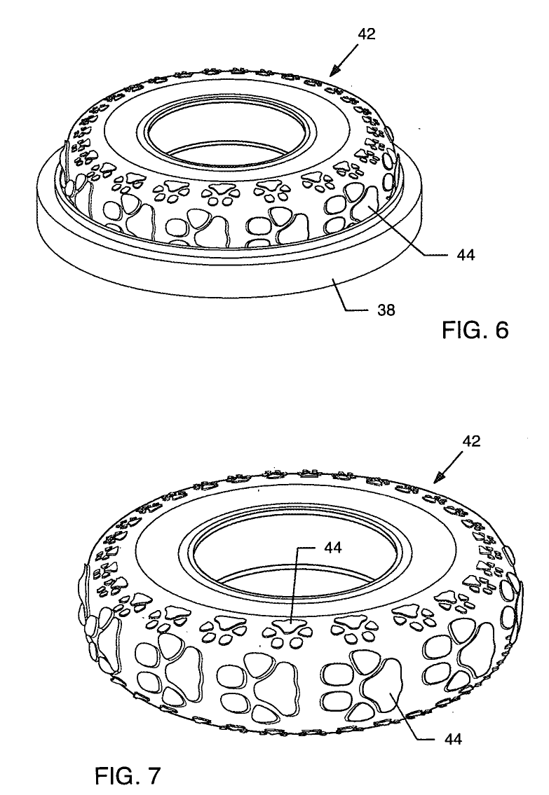

With reference to FIGS. 6 and 7, in a particularly preferred embodiment, the chew toy 42 is of a small tire configuration, typically ranging in size from six to ten inches in diameter. Such sizes have been found to be optimal as dogs of different sizes can bite onto a sidewall thereof, and carry the chew toy 42 or move it easily. For decoration purposes, a paw print 44 design may be formed on the tire chew toy as the tread. Other than its small size and optional unique tire tread design, the chew toy 42 appears very similar to an automobile tire. However, the chew toy 42 does not include the metal beads or wires of traditional automobile tires which can cause injury to the gums, tongue, etc. of the dog. Instead, the synthetic fibers 22 embedded within the chew toy 42 actually serve to floss and clean the teeth and gums of the animal chewing the toy 42.

Such small sized tire toys 42 can be used as retrieval toys as these are easily rolled or thrown by the dog's owner, and can be grasped and retrieved by the dog. The tire chew toys 42 can be produced in a black rubber, to simulate a real tire, or other colors, such as red, can be injected into the rubber material 10 to provide a very bright and attractive appearance to the dog. Cotton rope can be attached to the chew toy 42 for added chewing, and user dog-tugging; or buoyant foam can be added to the inside of the tire toy 42 so that the toy can be used as a floating chew toy and retriever.

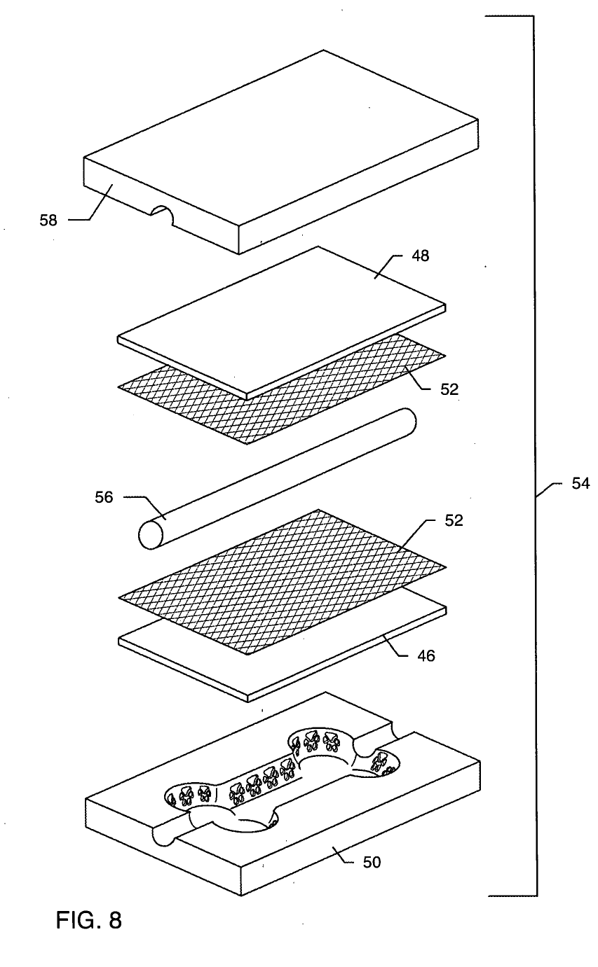

With reference now to FIGS. 8-17, other animal chew toy configurations can be produced using the present invention. Other methods of producing such animal chew toys comprised of tire rubber material and having fiber floss material embedded therein are also possible.

For example, as illustrated in FIGS. 8-12, layers or sheets of rubber material 46 and 48, which in accordance with the present invention are preferably comprised of a tire rubber material consisting of natural or synthetic rubber mixed with carbon black is provided. Although “tire rubber material” is preferred to mimic actual tires, it will be appreciated by those skilled in the art that natural rubber without carbon black may also be used. Such rubber materials may be colored, such as with red coloring or the like. The rubber layers 46 and 48 are cut to approximate the size and/or the eventual shape of the resultant animal chew toy. As seen from the base of the mold 50, the animal chew toy comprises a “dog bone” which is generally elongated and rectangular in shape. Thus, to avoid the wastage of rubber material, the sheets 46 and 48 are cut into rectangles or even bone-shaped sheets. One or more layers of floss material 52 are disposed between the layers of rubber 46 and 48. The floss material typically comprises a mesh fabric of synthetic fibers, such as nylon or polyester fibers, which serve to floss the animal's teeth and gums as the animal chews on the animal chewtoy, such as described above. In the mold 54 illustrated in FIG. 8, the resultant animal chew toy is hollow, thus a rod 56 is disposed between the layers of rubber material 46 and 48 and the lower and upper mold members 50 and 58.

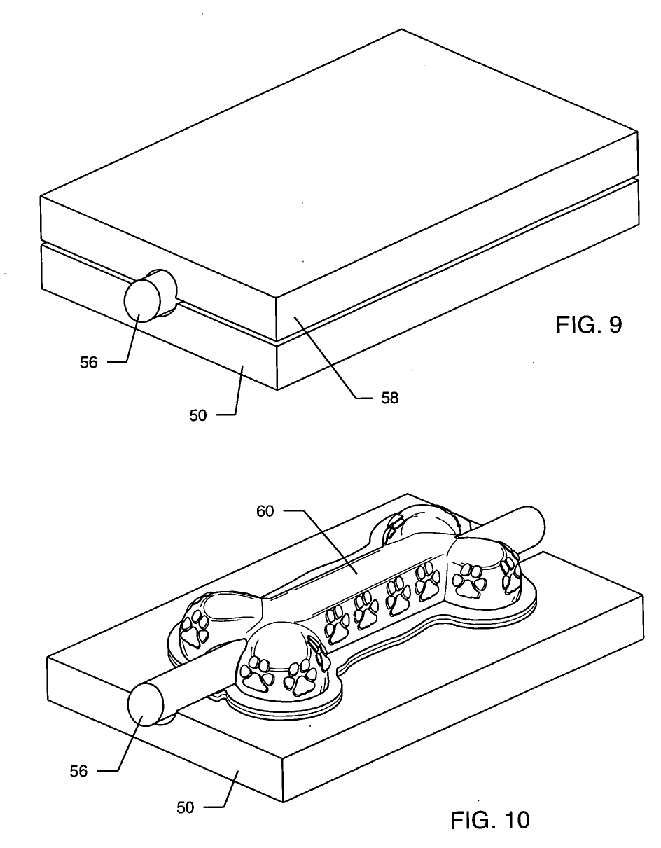

As illustrated in FIG. 9, the upper and lower mold members 50 and 58 are then brought towards one another to compress the sheets of rubber 46 and 48 and floss material 52. This is typically done under high pressure and elevated temperatures. High pressure alone can cause the rubber material to conform to the desired shape and embed the floss material 52 therein due to the increase in temperature caused by the compressive forces.

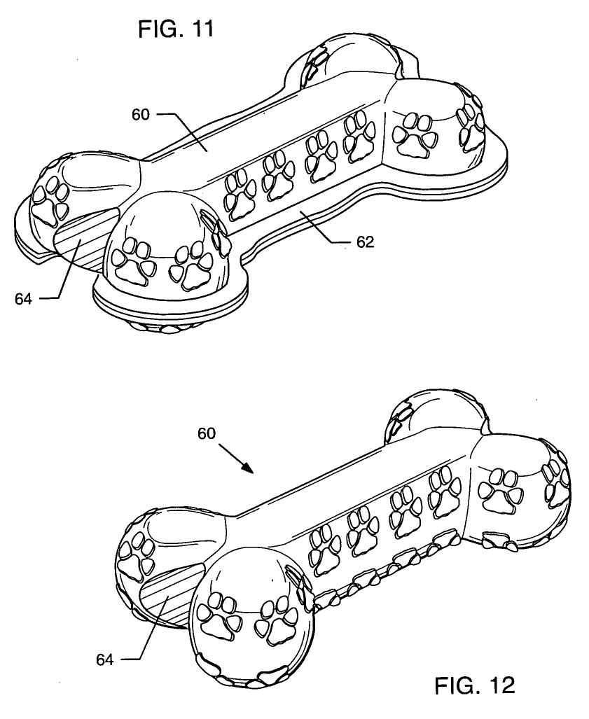

FIG. 10 illustrates the molded “dog bone” animal chew toy 60 remaining in the base 50 of the mold 54. As illustrated in FIG. 11, the animal chew toy 60 will typically have excess rubber material 62 which must be removed to achieve the resultant and final product, as illustrated in FIG. 12.

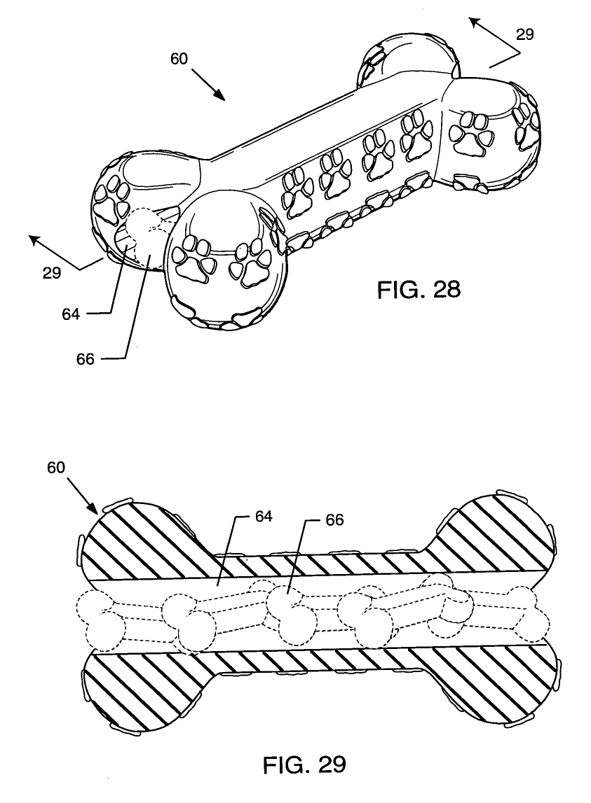

With reference now to FIGS. 28 and 29, the animal chew toy 60 is preferably hollow. This central aperture or cavity 64 can be exploited for different purposes. As illustrated in FIGS. 28 and 29, animal treats 66 may be disposed within the internal cavity 64. Such animal treats 66 can comprise pastes, such as peanut butter, small dog bones or crackers, as illustrated, a rawhide animal treat extending through the cavity 64 or the like. This provides added incentive for the dog or other animal to chew the toy 60 and attain the health benefits, particular to the animal's teeth, as described above.

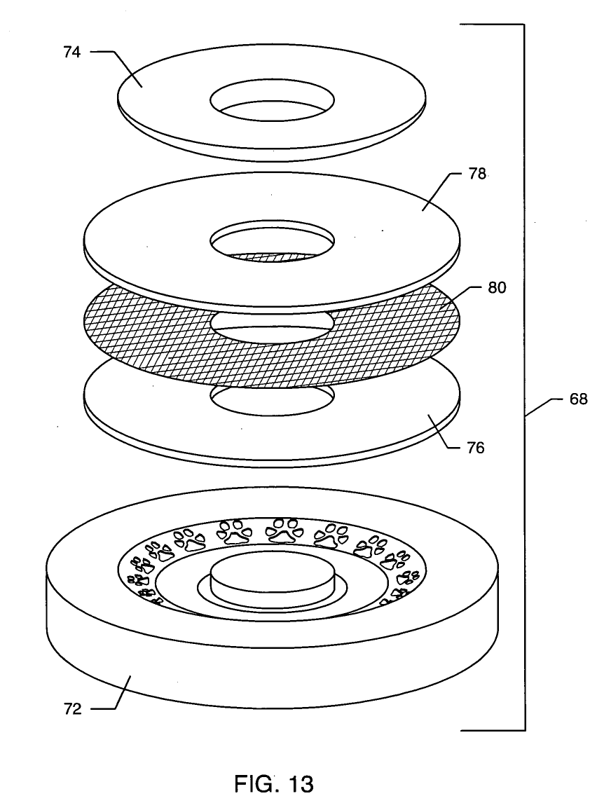

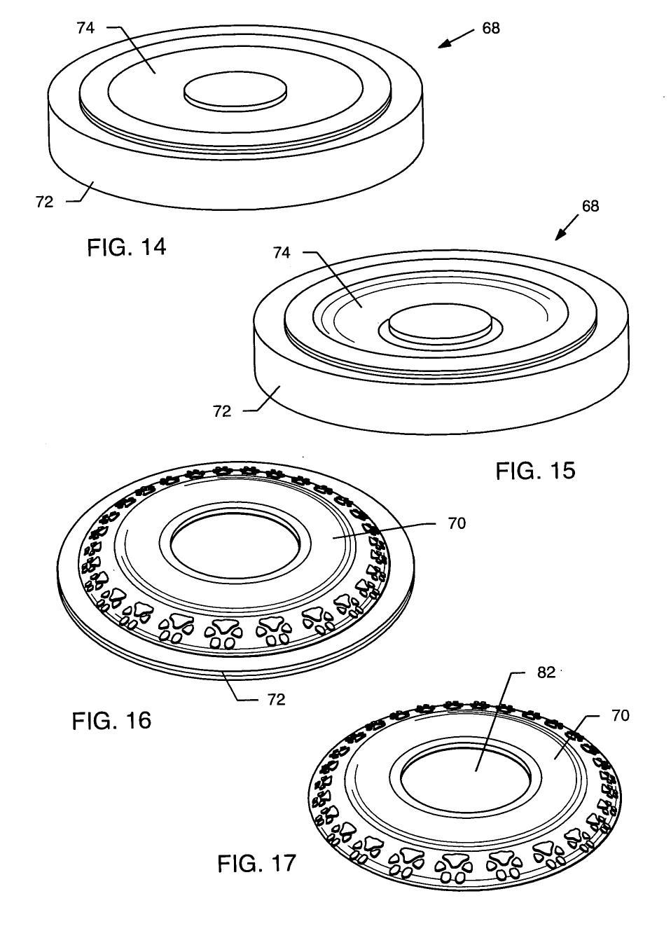

Other configurations of animal chew toys can be created using this process. For example, in FIGS. 13-21 a mold 68 is illustrated that is used to create a “flying disk” animal chew toy. The mold 68 again includes a lower mold member 62 and an upper mold member 74 which compress sheets or layers of rubber material 76 and 78 and an interposed layer of floss material 80. As described above, in a particularly preferred embodiment, the layers 76-80 are cut to an approximate size and shape of the resultant toy 70. As the flying disk animal chew toy 70 is generally disk-shape, with a central aperture, the layers 76-80 are similarly cut in preparation of the molding procedure. With reference to FIGS. 14 and 15, the upper and lower mold member 72 and 74 are compressed against one another at a given temperature and pressure and for a given length of time until the animal chew toy 70 is properly formed, as illustrated in FIG. 16.

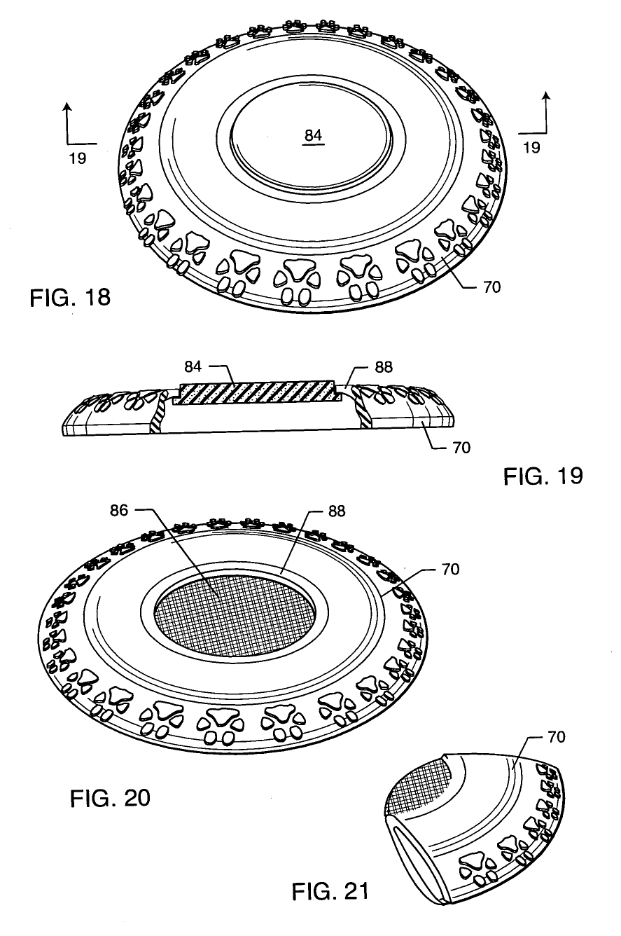

With reference to FIGS. 17-21, the “flying disk” animal chew toy 70 is disk-shaped and preferably has a central opening 82. Such central opening 82 not only saves in the amount of material used to produce the toy 70, but also enables the dog or other animal to easily grasp the toy 70. Given the fact that the toy 70 is comprised of tire rubber, the dog can actually bite into and more easily grasp the flying disk 70 as compared to rigid plastic flying disks or “frisbees”. Such rigid plastic can also be damaging to the dog's teeth. A central aperture area 82 can also be advantageously exploited to place a buoyant insert 84 therein so that the flying disk animal chew toy 70 can float in water. The insert 84 is typically comprised of a closed-cell foam material which is attached an inner circumference of the disk 70, as illustrated in FIGS. 18 and 19. Such can be done by adhering the foam insert 84 to the rubber material of the disk 70, or even sewing the insert 84 in place. Alternatively, the foam insert 84 could be designed such so as to be removably attached to the flying disk 70, such as by providing a circumferential groove about the insert 84 which would receive an inner lip of the flying disk toy 70.

Alternatively, as illustrated in FIG. 20, the central open area 82 of the animal chew toy 70 could be filled with a cloth material 86, such as by sewing the cloth material to the inner lip 88 of the flying disk 70. The cloth material 86 would allow the dog's teeth to extend therethrough when catching or retrieving the flying disk toy 70. This would allow the dog to more securely hold the disk toy 70, while also serving as a floss material to clean the dog's teeth and gums. As illustrated in FIG. 21, the flying disk animal chew toy 70 is preferably of a dimension and thickness so as to be folded for insertion into one's pocket, for example, when walking one's dog or in the park.

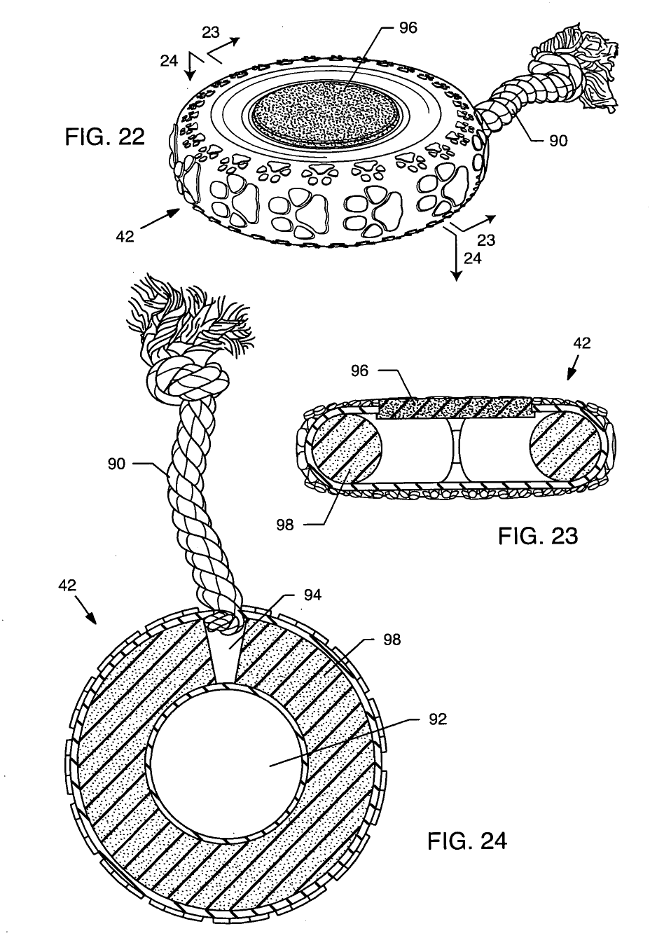

With reference now to FIGS. 22-24, the above-described tire chew toy configuration 42 could be constructed with the multiple-layer molding process or extrusion process described above. In either event, a length of rope 90 could be attached to the animal chew toy 42, such as by inserting the rope 90 through a sidewall thereof and forming a knot or the like, so that the animal chew toy 42 could be easily thrown by the dog's owner or the dog and owner could play tug-of-war or the like. Although the rope 90 could be comprised of various materials, preferably the rope is of a synthetic fiber, such as polypropylene/polyethylene, which may be similarly attached to the tire by means of a knot on the inside cavity of the tire toy 42, or by any other sufficient means. In a particularly preferred embodiment, either the central cavity 92 or inner “ring” cavity 94 could have a foam insert 96 or 98 inserted therein to render the toy 42 buoyant. Thus, the toy 42 could be thrown into a river or pond and float to allow the dog or other animal to retrieve it.

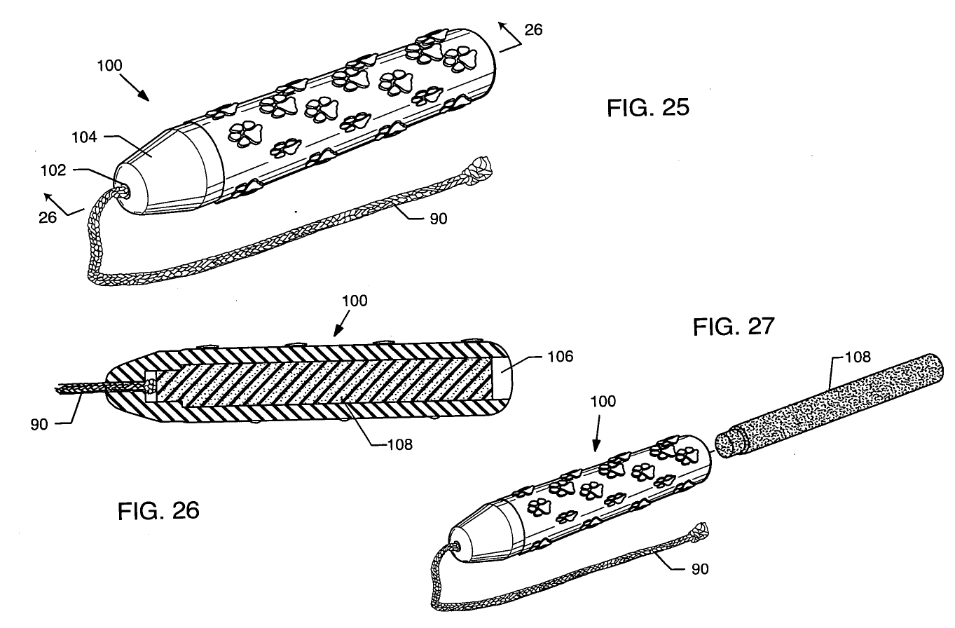

With reference now to FIGS. 25-27, yet another animal chew toy configuration in the form of a dog retriever 100 is illustrated. The retriever 100 can be constructed using either of the processes described above, and most preferably the multi-layer compression molding illustrated and described with respect to FIGS. 8 and 13. As such, the retriever toy 100 would be comprised of a tire rubber having floss material embedded therein for the benefit of the dog. In this toy configuration 100, a rope or string 90 extends through an aperture 102 of a generally solid portion 104 at the end of the toy 100. The toy 100 is constructed such that it is hollow or has an internal cavity 106. This cavity 106 can be exploited, as described above, to either retain animal treats or a buoyant insert 108 such that the toy 100 could float in water. Such buoyant insert 108, typically comprised of a closed-cell foam material, could be removably inserted in the toy, as illustrated in FIG. 27 in the event that the foam insert 108 was either undesirable or needed to be replaced with a new insert.

Although several embodiments have been described in detail for purposes of illustration, various modifications may be made without departing from the scope and spirit of the invention. Accordingly, the invention is not to be limited, except as by the appended claims.

What is claimed is:

1. A method for manufacturing an animal chew toy, comprising the steps of:
providing first and second layers of rubber material;
placing a floss material comprising a mesh fabric of synthetic fibers between the first and second layers of rubber material; and
molding the first and second layers of rubber and floss material into the animal chew toy.

2. The method of claim 1, wherein the first and second layers of rubber material and floss material are cut into the general shape or size of the animal chew toy.

3. The method of claim 1, wherein the rubber material comprises a tire rubber material.

4. The method of claim 3, wherein the tire rubber material comprises natural or synthetic rubber mixed with carbon black.

5. The method of claim 1, wherein the synthetic fibers of the mesh fabric comprise nylon or polyester fibers.

6. The method of claim 1, wherein the molding step includes the steps of compressing the first and second layers of rubber and floss material between opposing mold members under pressure and heat.

7. The method of claim 1, including the step of attaching a rope to the animal chew toy.

8. The method of claim 1, including the step of retaining an animal treat in a cavity of the animal chew toy.

9. The method of claim 1, including the step of associating a buoyant insert with the animal chew toy.

10. The method of claim 9, wherein the associating step comprises the step of inserting the buoyant insert into a cavity of the animal chew toy.

11. The method of claim 9, wherein the buoyant insert comprises a closed cell foam.

12. The method of claim 1, including the step of adding a scent material to the first and second layers of rubber.

13. The method of claim 1, wherein the animal chew toy is of a tire configuration and having a diameter of between six inches and ten inches, and wherein the tire animal chew toy does not include imbedded metal therein.

14. A method for manufacturing an animal chew toy, comprising the steps of:
providing first and second layers of a tire rubber material cut into a general shape or size of the animal chew toy;
placing a floss material comprising a synthetic fiber mesh cut into the general shape or size of the animal chew toy between the first and second layers of rubber material; and
compressing the first and second layers of rubber and floss material under pressure and heat to mold the first and second layers of rubber and floss material into the animal chew toy.

15. The method of claim 14, wherein the tire rubber material comprises natural or synthetic rubber mixed with carbon black.

16. The method of claim 14, wherein the synthetic fibers of the mesh fabric comprise nylon or polyester fibers.

17. The method of claim 14, including the step of attaching a rope to the animal chew toy.

18. The method of claim 14, including the step of retaining an animal treat in a cavity of the animal chew toy.

19. The method of claim 14, including the step of associating a buoyant insert within a cavity of the animal chew toy.

20. The method of claim 14, including the step of adding a scent to the layers of rubber.

21. A method for manufacturing an animal chew toy, comprising the steps of:
providing first and second layers of a tire rubber material comprised of natural or synthetic rubber mixed with carbon black and cut into a general shape or size of the animal chew toy;
placing a floss material comprising a nylon or polyester fiber mesh cut into the general shape or size of the animal chew toy between the first and second layers of rubber material; and
compressing the first and second layers of rubber and floss material under pressure and heat to mold the first and second layers of rubber and floss material into the animal chew toy.

22. The method of claim 21, including the step of attaching a rope to the animal chew toy.

23. The method of claim 21, including the step of retaining an animal treat in a cavity of the animal chew toy.

24. The method of claim 21, including the step of associating a buoyant foam insert within a cavity of the animal chew toy.

25. The method of claim 21, including the step of adding a scent material to the layers of rubber.
